(19) United States
(12) Patent Application Publication
(10) Pub. No.: US 2026/0086750 A1
(43) Pub. Date: Mar. 26, 2026

(54) METHODS AND PRINTING SYSTEM FOR ENHANCED JOB SUBMISSION IN A PRINTING SYSTEM

(71) Applicant: Kyocera Document Solutions Inc., Osaka (JP)

(72) Inventor: Javier A. MORALES, Rochester, NY (US)

(73) Assignee: Kyocera Document Solutions Inc., Osaka (JP)

(21) Appl. No.: 18/892,836

(22) Filed: Sep. 23, 2024

(51) Int. Cl. G06F 3/12

(52) U.S. Cl. CPC G06F 3/1268; G06F 3/1204

(57) ABSTRACT

A printing system includes printing devices that receive print jobs. A printing device includes a controller having a raster image processing (RIP) system. The controller of the printing device receives a file for a job through a user interface connected to the controller. The controller uploads the file for the job. A simplified user interface is displayed that corresponds to the controller during the uploading of the file. The simplified user interface includes a defined subset of print ticket settings for the job. The controller receives one or more print ticket settings of the defined subset of print ticket settings within the simplified user interface to apply to the job. The controller releases the job for operations within the printing device upon receipt of the one or more print ticket settings and the uploaded file.

### FIELD OF THE INVENTION

The present invention relates to a printing system and associated methods that enhance print job submission within a printing system having a printing device. More particularly, the present invention relates to a printing system and method for submitting print jobs within the printing system having an enhanced drag and drop capability.

### DESCRIPTION OF THE RELATED ART

Drag and drop print job submission may be common in production print environments. One clicks on the job and drags it to a folder or interface to have the print job be printed at one or more printing devices. This process typically is used to add jobs to a digital front end (DFE), or controller, of the one or more printing devices. In the operations, the operator defines print ticket settings and releases the job for printing. This process does not support a streamlined workflow due to the manual job configuration of the print ticket settings. The operator uploads the job into the controller and then interacts with the job before releasing it for printing.

### SUMMARY OF THE INVENTION

A method for submitting a print job for printing within a printing system is disclosed. The method includes receiving a file for a print job through a user interface for a digital front end (DFE) of a first printing device. The method also includes uploading the file for the print job within the printing system. The method also includes displaying a simplified user interface corresponding to the DFE during the uploading of the file for the print job to the DFE. The simplified user interface includes a defined subset of print ticket settings for the print job. The method also includes receiving at least one print ticket setting of the defined subset of print ticket settings within the simplified user interface to apply to the print job. The method also includes releasing the print job for printing operations by the DFE upon receipt of the at least one print ticket setting and upload of the file for the print job.

A method for submitting a print job within a printing system is disclosed. The method includes receiving a file for a print job through a user interface for a digital front end (DFE) of a first printing device. The method also includes uploading the file for the print job within the printing system. The method also includes defining a subset of print ticket settings of a plurality of print ticket settings based on tracked usage of the plurality of print ticket settings. The method also includes generating a simplified user interface corresponding to the DFE during the uploading of the file for the print job to the DFE. The simplified user interface includes the defined subset of print ticket settings for the print job. The method also includes receiving at least one print ticket setting of the defined subset of print ticket settings within the simplified user interface to apply to the print job. The method also includes releasing the print job for printing operations by the DFE upon receipt of the at least one print ticket setting and upload of the file for the print job.

A printing system is disclosed. The printing system includes a first printing device having a digital front end (DFE). The printing system also includes a user interface connected to the DFE. The DFE includes a processor and a memory. The memory stores instructions that, when executed on the processor, configures the DFE to receive a file for a print job through the user interface. The processor also configures the DFE to upload the file for the print job. The processor also configures the DFE to display a simplified user interface corresponding to the DFE during the uploading of the file for the print job to the DFE. The simplified user interface includes a defined subset of print ticket settings for the print job. The processor also configures the DFE to receive at least one print ticket setting of the defined subset of print ticket settings within the simplified user interface to apply to the print job. The processor also configures the DFE to release the print job for printing operations by the DFE upon receipt of the at least one print ticket setting and upload of the file for the print job.

### BRIEF DESCRIPTION OF THE DRAWINGS

Various other features and attendant advantages of the present invention will be more fully appreciated when considered in conjunction with the accompanying drawings.

FIG. 1 illustrates a printing system for managing jobs according to the disclosed embodiments.

FIG. 2 illustrates a block diagram of components of the printing device for use within the printing system according to the disclosed embodiments.

FIG. 3 illustrates a block diagram of a RIP system for use in processing a job in the printing system according to the disclosed embodiments.

FIG. 4 illustrates a block diagram of an example RIP used within the RIP system according to the disclosed embodiments.

FIG. 5 illustrates a block diagram of a simplified user interface interacting with a controller of a printing device for submitting a job according to the disclosed embodiments.

FIG. 6 illustrates a block diagram of modifying a subset of the print ticket settings based on use according to the disclosed embodiments.

FIG. 7 illustrates a flowchart for submitting a job using a simplified user interface according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide enhancements to drag and drop job submission in order to enable complete job submission. This feature may eliminate the need for additional interactions before a job is released for printing after being uploaded.

When the operator drags and drops a supported page description language (PDL) file into the DFE, or controller, user interface, the disclosed embodiments start uploading the file immediately in the background. The disclosed embodiments display a simplified user interface to allow the operator to immediately define print ticket settings for the job. The simplified user interface will have a limited number of print ticket settings. For example, the print ticket settings may include DFE queue, job name, project name, copies, a paper catalog selection or a job action. Job actions include print, process and hold, proof and hold, estimate, and the like. The print ticket settings available in the simplified user interface may be configurable via DFE settings.

In some embodiments, the simplified user interface may allow the operator to select the target printing device to use for job submission. If the operator selects a printing device other than the one to which the DFE is connected, then the disclosed embodiments will upload the job directly to the selected printing device. Alternatively, the disclosed embodiments may upload the job to the current printing device but them immediately forward the job to the selected printing device. The disclosed embodiments also my delete the job after it is forwarded to the target printing device.

The user interface also may provide the operator the option to expand the print ticketing user interface from the simplified user interface to a complete print ticketing user interface. This feature would be useful for cases in which the operator needs to specify settings that are unavailable in the simplified user interface. The printing system also may temporarily hold jobs that complete uploading before the operator has defined all print ticket settings.

Once the operator specifies the selected settings, he or she may “submit” the job. The print ticketing user interface is dismissed. The resultant print ticket is uploaded to the DFE where it will be associated with the uploaded file. The job will be released for processing based on the selected job action. If the operator chooses to cancel the submission, then the printing system may cancel the job upload if it is still in progress. Otherwise, the disclosed embodiments delete the job from the DFE if the upload is completed.

In some embodiments, the disclosed embodiments also may track which print ticket settings are actually used by the operators. If there are attributes that are not used, then the print system may either remove them automatically or it may suggest that the print ticket item be removed from the simplified user interface. Alternatively, if operators commonly expand the simplified user interface into the complete user interface in order to access unavailable settings, then the printing system automatically may add those settings to the simplified user interface.

The print ticket setting use tracking may be done either globally or per item basis. For example, the disclosed embodiments may track on a user, queue, PDL type, or job action basis. For example, based on print ticket use, the user interface may display different settings for printing versus estimating jobs. The disclosed embodiments also may combine the above print ticket use tracking to offer more granular settings.

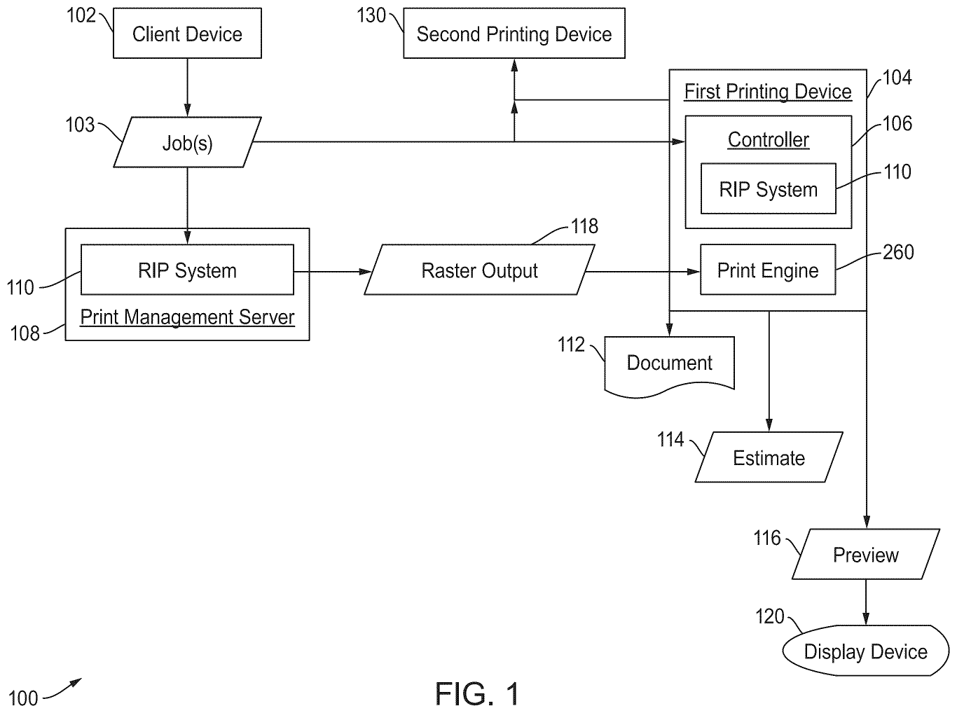

FIG. 1 depicts a printing system 100 for managing jobs using RIP system 110 according to the disclosed embodiments. Printing system 100 may be located in a print shop or other environment suitable for production printing operations. Printing system 100 includes one or more printing devices 104 and 130 that receive jobs 103 from one or more client terminals 102.

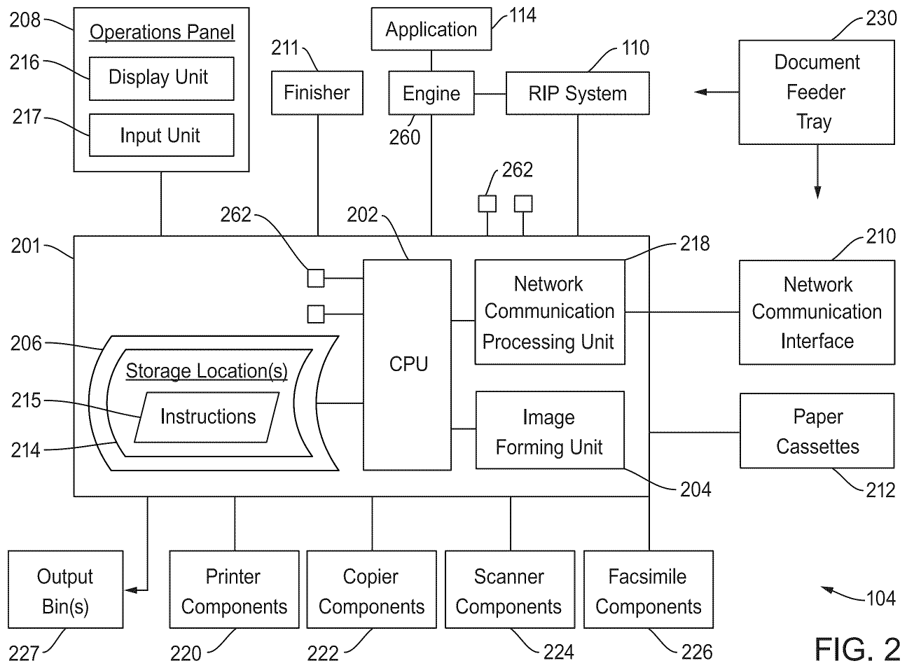

Printing device 104 receives jobs through printing system 100, such as job 103. Printing device 104 also may be referred to as first printing device 104. In some embodiments, job 103 is a print job. After processing job 103, printing device 104 may print or produce document 112 in a paper or media specified by the print job. Printing device 104 is disclosed in greater detail in FIG. 2. Printing device 104 also includes a controller, or digital front end (DFE), 106, which facilitates processing job 103. Controller 106 also includes RIP system 110, which is disclosed in greater detail below.

For example, controller 106 may use RIP system 110 to convert bitmap images, vector graphics, fonts, and the like associated with pages in job 103 to bitmap/rasterized representations of the pages, such as C, M, Y, and K pixels. The sum of the values of pixels of a particular color in the rasterized pages may be proportional to the amount of consumables used by printing device 104 to print that color. RIP system 110 may rasterize pages of job 103 according to various image rasterization settings. For example, these image rasterization parameters may include calibration curves, paper definitions, ICC profiles, spot color definitions, TRCs, color conversion settings, colorant limits for ink or toner, rendering intent, K preservation, CGR level, max colorant densities, print margins, halftones, and the like.

System 100 also includes second printing device 130. Second printing device 130 may receive jobs 103 from client device 102 or print management server 108 as well. In some embodiments, printing device 104 acting as a first printing device may upload a job within system 100 then forward it to second printing device 130. The job may be forwarded with print ticket settings to second printing device 130 from first printing device 104. Alternatively, system 100 may upload job 103 directly to second printing device 130 while controller 106 of first printing device 104 obtains the print ticket settings for the job.

Print engine 260 also is included with printing device 104. Printing device 104 may correspond to an industrial printing device capable of printing thousands of pages in an hour. Printing device 104 may be ink-based, toner-based, or both. Print engine 260 may include various parameters that can control the operation of printing device 104. For example, these settings may include printing device maintenance settings that control or effect head cleaning intervals, head clogging prevention intervals, and the like of printing device 104. Print engine 260 receives raster output from RIP system 110 in printing device 104 to print document 112 based on job 103.

Printing system 100 receives job 103 and may route it directly to printing device 104 or 130. Alternatively, printing system 100 may route job 103 to print management server 108. Print management server 108 may seek to offload processing of job 103 from controller 106 of printing device 104. This feature may be desirable if controller 106 does not have the processing capacity to handle jobs 103 in a production printing environment. Thus, print management server 108 also may include RIP system 110 that can provide raster output 118 directly to print engine 260 of printing device 104. These embodiments allow controller 106 to offload processing in order to handle other operations. Further, updates to RIP system 110 may occur at print management server 108 prior to any updates to RIP system 110 in printing device 104.

Job 103 is not always a print job that produces document 112. In some embodiments, job 103 may be an estimation job or a preview job. In other embodiments, job 103 may be a process and hold job or a proof and hold job. A job action print ticket setting may be defined to indicate which type of job is being received. RIP system 110 determines which type of job is job 103 and configures itself accordingly. For an estimation job, RIP system 110 configures RIPs to process job 103 without impacting print processing within controller 106. The estimation RIPs process job 103 to provide an ink or toner estimate 114. Estimate 114 may be provided to an operator without engaging print engine 260.

For a preview job, RIP system 110 configures RIPs to process job 103 to quickly generate a lower resolution output as preview 116. Preview 116 may be a lower resolution output as compared to document 112 and estimate 114. Preview 116 is provided to the operator to review. Preview 116 may be provided to display device 120 for the operator to review and interact with using an interface. Display device 120 may be a separate device from client device 102 and printing device 104. In other embodiments, display device 120 may be incorporated within client device 102 or printing device 104.

RIP system 110 may be a smart system that enables optimal processing by using page complexity determination to handle a variety of jobs 103. Different jobs received at printing device 104 or print management server 108 result in different output, such as document 112, estimate 114, or preview 116. The RIP instances within RIP system 110 are configured according to the type of job 103 is received.

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within printing system 100. As disclosed above, printing device 104 may send and receive data from client device 102, print management server 108, if a separate device, and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays. Paper cassettes 212 may include papers having various sizes, colors, composition, and the like. Papers or media within paper cassettes 212 may be considered “loaded” onto printing device 104. The information for printing these papers may be captured in a paper catalog stored at controller 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from print management server 108. Display unit 216 may act as display device 120 for displaying preview 116 after it is generated by RIP system 110.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. RIP system 100 that interprets the page description languages (PDLs) would transmit and send instructions down to the lower-level engine 260 for actual rendering of an image and application of the ink onto paper during operations on printing device 104. RIP system 110 may be located in controller 106, as disclosed above. Alternatively, RIP system 110 may be located on print management server 108 and directly communicates with print engine 260.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device.

Memory unit 206 may store the history of failure events and occurred errors with a timestamp of each error. Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from client device 102 and print management server 108 as well as other printing devices within printing system 100.

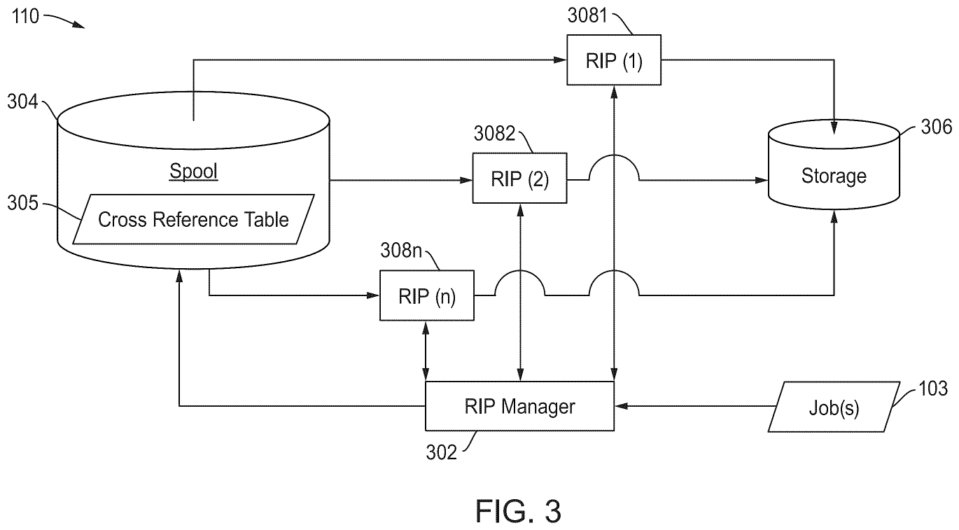

FIG. 3 depicts a block diagram of RIP system 110 for use in processing job 103 in printing system 100 according to the disclosed embodiments. As disclosed above, RIP system 110 may be located in controller 106 of printing device 104. It also may be located on print management server 108 such that it communicates directly with print engine 260 of printing device 104.

RIP system 100 include RIP manager 302 and RIP instances RIP 3081, RIP 3082, and RIP 308n. A RIP instance may be a RIP configured by RIP manager 302 to process job 103. A RIP instance may be a standard RIP, a high performance RIP, a very high performance RIP, a preview RIP, an estimation RIP, or a failover RIP. All RIP instances and RIP manager 302 operate in parallel to each other.

RIP manager 302 performs a variety of operations. It may contain multiple subunits that operate in parallel to perform the variety of operations, like spooling job 103, managing job 103, managing pages or segments of job 103, managing RIP instances 3081, 3082, and 308n, managing drives, determining the PDL type of job 103, distributing pages of segments of job 103 to the RIP instances, serializing pages or segments of job 103, sending notifications within printing device 104 or print management server 108.

RIP manager 302 may receive job 103 through printing system 100. Job 103 may be received from client device 102 via internet protocols within printing system 100. Job 103 may be spooled by RIP manager 302 and stored in spool drive 304. Spool drive 304 may be a configurable drive. RIP manager 302 determines the PDL type of job 103. It then creates a cross reference table 305 in spool drive 304, which acts as a shared memory with RIP instances 3081, 3082, and 308n. RIP manager 302 also may create print ticket information in spool drive 304.

RIP manager 302 analyzes job 103 to determine which type of job it is. It uses this information to determine the number of RIPs and type of RIPs to be used in processing job 103. Depending on the type of job, RIP manager 302 configures RIP instances 3081, 3082, and 308n. A configuration operation may create a RIP having a certain number of renderers. For example, RIP instance 3081 may be a standard RIP having a normal number of renderers, such as 4. RIP instance 3082 may be a high performance RIP that has a higher number of renders, such as 6. RIP manager 302 configures the RIP instances accordingly to process job 103.

RIP manager 302 then distributes pages or segments of job 103 to RIP instances 3081, 3082, and 308n. Job 103 may be a print job that is split into segments or pages for parallel processing. As RIP instance 3082 is a high performance RIP, then it may receive specific pages or segments of job 103. Pages may refer to one or more pages of job 103. Segments of job 103 also may refer to a number of pages or a block of data within job 103. The pages or segments are distributed by front end 302 using inter-process communication.

RIP instances 3081, 3082, and 308n may read cross reference table 305 along with print ticket information and the spooled data for job 103. Each RIP instance then processes the page or segment that it is instructed to by RIP manager 302. The RIP instance may check cross reference table 305 to obtain any instructions in the print ticket information and the data for the page or segment in spool drive 304. RIP instances 3081, 3082, and 308n then parse the data for the page or segment to create metadata from the drawing commands.

The RIP instances render the metadata to storage 306. Storage 306 may store the rendered pages for a print job of job 103. The rendered pages may be stored according to a specific image format, such as the KYOCERA™ Image Format (KIF). The stored pages may then be provided to print engine 260 to print document 112. For jobs 103 that do not require rendered pages, such as previews and estimates, the data generated by the RIP instances may be provided back to front end 302 for further operations.

RIP system 110 provides advantages over conventional RIP systems. RIP manager 302 may control the number of renderers per RIP. It may increase the number to process a page or segment faster. It also may increase the amount of memory allocated to the RIP as faster processing consumes more memory. If processing is to be slower, such as for estimate 114 or preview 116, then the configured RIP should consume less memory. RIP manager 302 manages these requirements through dynamic configuration of the RIPs based on the parameter of job 103.

In some instances, RIP manager 302 may determine that job 103 is not able to be split into pages or segments for parallel processing. Thus, it may configure a RIP instance, such as RIP instance 308n, into a very high performance RIP. The very high performance RIP uses more renderers than the high performance RIP. For example, RIP instances 308n may be configured to use 8 renderers. This feature increases the processing speed of RIP instance 308n. Front end 302 may still use RIP instances 3081 and 3082 for parallel processing on one job 103 while using RIP instance 308n for processing another job 103 that is not able to be broken into pages or segments.

RIP system 110 provides features available due to the parallel processing using dynamically configured RIP instances. RIP system 110 may configure a high performance RIP to improve the first page out time. It also may use differently configured RIPs for different purposes, such a preview RIPs, estimation RIPs, and failover RIPs. RIP system 110 also may configure very high performance RIPs for jobs that cannot be processed in a page or segment parallel manner.

RIP system 110 also provides the ability to change the number of renderers per RIP. RIP system 110 also changes the number of RIP instances based on its workload, which includes shutting down certain types of RIPs in order to launch other types of RIPs. RIP system 100 also processes different kinds of jobs in RIPs with different configurations. RIP system 110 also uses different RIPs with different configurations for different purposes. It configures RIP instances with different imaging pipelines. RIP system 110 also retries failed jobs or job pages in a differently configured RIP instance.

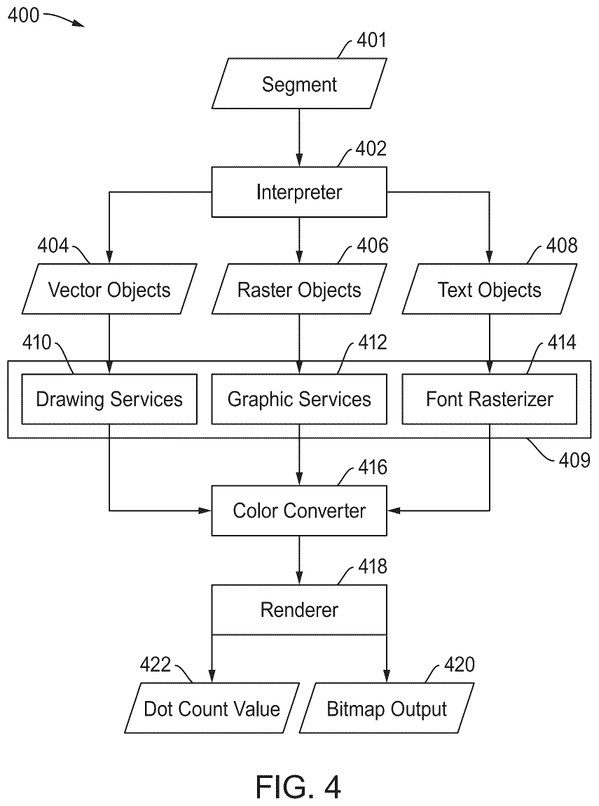

FIG. 4 depicts a block diagram of an example RIP 400 used within RIP system 110 according to the disclosed embodiments. RIP 400 may represent a configuration for RIP instances 3081, 3082, or 308n. RIP 400 may represent the hardware and software configuration used to determine what value each pixel or spot of output should possess, driven by commands from a page description language (PDL). Computer-generated output may be composed of very small spots. RIP 400 converts a vector-based image, or a stored image, into a series of mathematical formulas that describe lines and curves into a pattern of spots needed to generate the output, or raster image. Interpreter 402 converts a job file into a display list, which is then converted into a bitmap output 418 describing a page of the document.

RIP 400 converts text and image data from different file formats including PDF, TIFF, or JPEG into a format that printing device 104 can understand. The process of raster image processing a page implements several steps to be performed, regardless whether the page is submitted as PostScript, PDF, or any other page description language (PDL). In short, RIP 400 may provide interpretation, rasterization, and screening.

Segment 401 may be a job file associated with job 103. Segment 401 may be provided to RIP 400 to convert its code into raster or bitmap code. As disclosed above, front end 302 receives job 103. Front end 302 may split job 103 into segments for parallel processing by the RIP instances. Preferably, segment 401 is a page the document in job 103. RIPs process pages in a parallel manner within RIP system 100. RIP 400 is one of the RIP instances. In other embodiments, segment 401 may be several pages, a graphic design, or other portion of job 103.

Segment 401 is received at interpreter 402, which interprets the commands in the code to redraw the object and elements of a page as vector objects 404, raster objects 406, and text objects 408. Interpreter 402 parses specific PDLs into drawing commands. The PDL of segment 401 is read and decoded into graphical elements to be placed on a sheet. Each element may be an image, a character of text, a fill, stroke, and the like or listed in vector objects 404, raster objects 406, and text objects 408.

Drawing unit 409 receives vector objects 404, raster objects 406, and text objects 408 to convert the drawing commands into metadata that can be provided to renderer 418. Thus, drawing unit 409 converts vector objects 404 into drawing services 410. It also converts raster objects 406 into graphic services 412. It also converts text objects into font rasterizer 414.

RIP 400 also may implement color converter 416. Color converter 416 may implement color conversion operations for the metadata generated by drawing unit 409. Color converter 416 provides color management and calibration. These actions may be applied during interpretation or rendering, depending on configuration and job content. Color printing resources may be accessed to provide the color management.

Renderer 418 processes the metadata from drawing unit 409 to convert every graphical element into the appropriate pattern of pixels to form the output raster. The resolution independent vector objects 404 as drawing services 410 are converted into pixels. Screening takes the raster image of pixels to form individually screened cyan, magenta, yellow, and black separations. These are halftone dots in the form of a bitmap output 420 consisting of commands that can be understood by print engine 260.

The disclosed embodiments also may determine dot count value 422 from the rendered image provided by renderer 418. Dot count values may be adjusted based on screening and based on settings at printing device 104. Dot count value 422 may be reported to determine estimate 114 for an estimation job, as disclosed below.

The rendered bitmap output 420 may be stored in storage 306 to be sent to print engine 260 when all the pages or segments of job 103 are processed. RIP 400 shows one path for rendering and providing output. Preferably, RIP 400 multiple rendering paths that use multiple renderers. The disclosed embodiments may use a renderer 418 for each channel in RIP 400, such as one each for cyan, magenta, yellow, and black. The number of renderers 418 may be configured by front end 302 depending on job 103. Each renderer 418 requires memory and processing resources. A high number of renderers 418 in RIP 400 will consume more memory but run faster. A lower number of renderers 418 in RIP 400 will consume less memory but run slower.

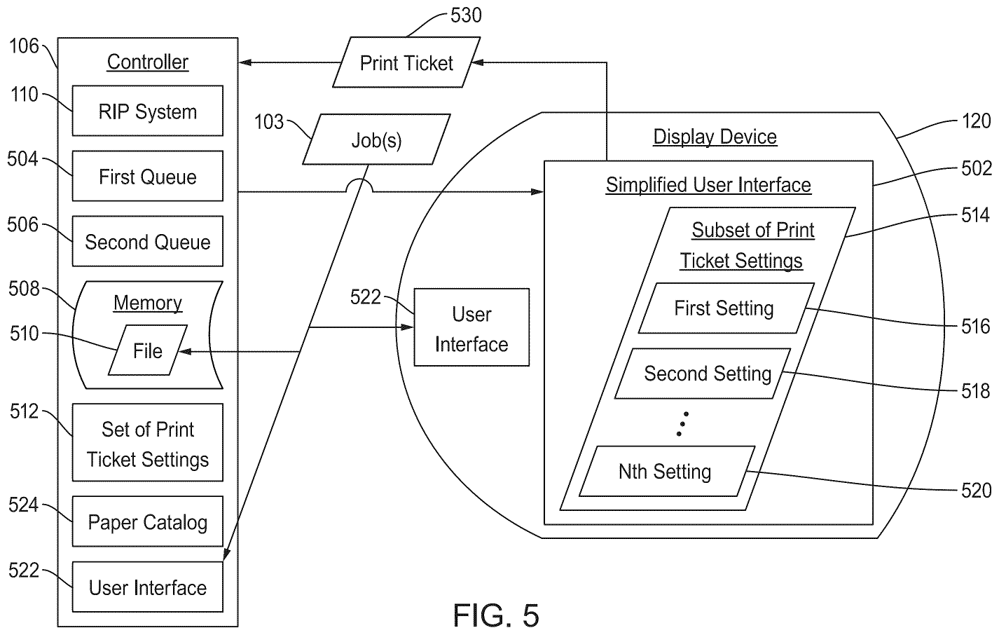

FIG. 5 depicts a block diagram of a user interface 502 interacting with controller 106 of printing device 104 for submitting a job 103 according to the disclosed embodiments. FIG. 5 may include components within print system 100 disclosed above but shown in additional detail here. Controller 106 may be associated with printing device 104 in that jobs are submitted to print engine 260 for printing. In these embodiments, however, job 103 is dragged and dropped into a user interface 522 for controller 106. User interface 522 may be on printing device 104 and part of controller 106. Alternatively, user interface 522 may be displayed on display device 120 within system 100.

In some embodiments, the drag and drop operation for job 103 to user interface 522 may result in print ticket settings needing to be defined. These settings are applied to processing job 103 within controller 106 or printing device 104. In the disclosed embodiments, when job 103 is “dropped” into user interface 522, a file 510 of job 103 begins uploading to memory 508 of controller 106. Memory 508 may be specific to controller 106. Alternatively, memory 508 may corresponds to memory unit 206, disclosed above. File 510 may be uploaded in the background of other operations, as disclosed below.

Upon receipt of job 103, controller 106 may launch a simplified user interface 502 to allow the operator to immediately define print ticket settings for job 103. A subset 514 of print ticket settings is displayed in simplified user interface 502. Subset 514 may be configured based on a set 512 of print ticket settings supported by controller 106. Set 512 may include all the applicable print ticket settings for a job at printing device 104. These settings may include controller, or DFE, settings specific to how jobs are printed at printing device 104.

For example, the DFE settings may include one for whether spot color overprints should be enabled by default. This setting may be changed at the job level. Other DFE settings may not be able to be changed at the job level, such as whether spot color matching is case sensitive or not or whether to generate detailed ink use information after a job is estimated or processed. The DFE settings may be included in set 512.

Subset 514 includes a limited number of print ticket settings. For example, a normal user interface, such as controller user interface 522, may display 80 or more print ticket settings from set 512. Simplified user interface 502 may display about 6 print ticket settings. As shown, subset 514 includes first print ticket setting 516, second print setting 518, up to Nth print ticket setting 520.

An example of a print ticket setting made available in subset 514 includes size, weight, print condition, and other attributes of the paper selected for job 103. Other examples include which controller queue to use within controller 106. Controller 106 may include a first queue 504 and a second queue 506. Other queues may be included. First queue 504 may pertain to certain types of jobs or to a specific attribute of the job. Second queue 506 may pertain to a different type or another specific attribute. For example, first queue 504 may be for jobs requiring color printing while second queue 506 may be for jobs not requiring color printing.

Another example of a print ticket setting made available in subset 504 includes a job name or project name for job 103. Another possible setting is the number of copies of document 112 to be printed for job 103. Print ticket settings also include a paper catalog selection of a paper to be used for job 103. Controller 106 may include a paper catalog 524, which stores all the attributes and information about the papers available for printing on printing device 104. In some embodiments, paper catalog 524 may be stored at print management server 108. Papers may be added and removed from paper catalog 524 during operations. Controller 106 may update subset 514 with print ticket settings related to the changes on the papers in paper catalog 524.

Subset 514 also may include print ticket settings for the job action. The job action relates to what printing device 104 is supposed to do with job 103 after it is rendered by RIP system 110. For example, a job action may be print, process and hold, proof and hold, preview, or estimate for a job. These actions may differ from each other in how RIP system 110 handles job 103 during printing operations. For example, a preview or estimate job may not be sent to print engine 260.

In some embodiments, simplified user interface 502 may include a print ticket setting of subset 514 that allows the operator to select a target printing device to use for job submission. For example, even though job 103 was “dropped” into controller user interface 522 for controller 106 of printing device 104, the target printing device to print document 112 is second printing device 130. Thus, file 510 is provided to second printing device 130 for printing operations. System 100 may upload file 510 directly to second printing device 130. The current upload to memory 508 may be interrupted and switched to second printing device 130. Alternatively, system 100 may upload file 510 to printing device 104. Printing device 104 forwards file 510 for job 103 to second printing device 130 once uploading is complete. File 510 then is deleted from memory 508 of controller 106.

Simplified user interface 502 may provide the operator the option to expand subset 514 of print ticket settings to a complete print ticking user interface. For example, the operator may select a setting that expands subset 514 to include set 512 of the print ticket settings available for printing device 104. This feature is useful for those instances in which the operator needs to specify settings that are not available in simplified user interface 502.

Once file 510 is uploaded, it may be released to controller 106, queues 504 and 506, RIP system 110, and the like for further printing operations. The disclosed embodiments may hold job 103 even if file 510 completes uploading until the operator defines all print ticket settings, or cleared simplified user interface 502 of subset 514 of the applicable print ticket settings. Once the operator specifies the selected settings, he or she “submits” job 103 to controller 106, or to a target printing device. Print ticket 530 is uploaded to controller 106 where it will be associated with uploaded file 510. Job 103 may be released for printing operations based on the selected job action from the print ticket settings of subset 514 provided by simplified user interface 502.

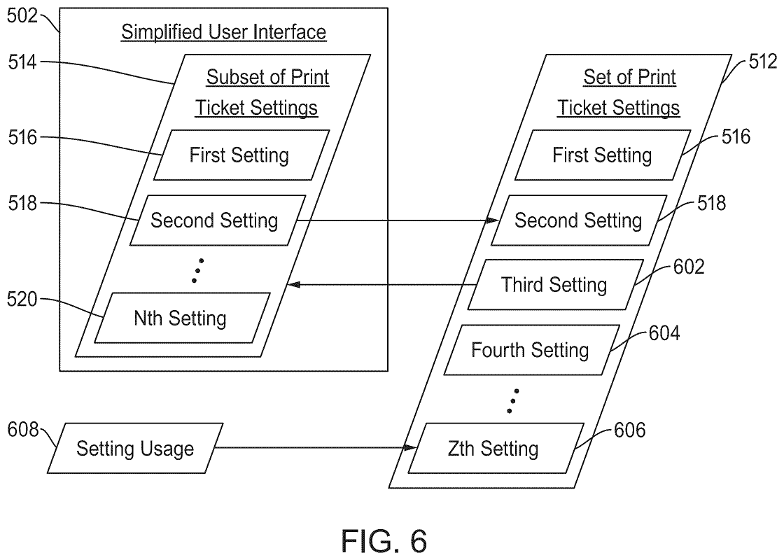

FIG. 6 depicts a block diagram of modifying subset 514 of the print ticket settings based on use according to the disclosed embodiments. As disclosed above, subset 514 of print ticket settings includes a smaller number of settings than those within set 512 of print ticket settings. Set 512 includes all the print ticket settings available for jobs within system 100 or at printing device 104. The disclosed embodiments may modify the print ticket settings within subset 514 that are provided in simplified user interface 502. For example, settings may be added or removed from subset 514.

Printing system 100 may track which print ticket settings actually are used by operators. Those settings should be the ones presented in simplified user interface 502. If there are settings now used in print system 100, then the disclosed embodiments may remove them from subset 514. Alternatively, the disclosed embodiments may recommend removal of the setting from subset 514. The recommendation may be presented to the operator(s) through simplified user interface 502.

In some embodiments, if operators commonly expand simplified user interface 502 into a complete controller user interface 522 in order to access unavailable settings, then the disclosed embodiments may add those settings to subset 514 for display in the simplified user interface. The disclosed embodiments may track these actions and generate setting usage 608. Controller 106 may track actions taken using simplified user interface 502 over a period of time. The actions indicate which settings have been used in printing operations through simplified user interface 502.

For example, setting usage 608 may show that second setting 518 is rarely used during the observation period, such as two months. When operators use simplified user interface 502, second setting 518 is not selected according to a specified amount, such as with 20% of jobs received at controller 106. The disclosed embodiments may automatically recommend that settings below the specified amount be removed from subset 514. The operator may approve removal of second setting 518 from subset 514.

In addition, second setting 518 may be replaced with another setting from set 512. Set 512 includes all available print ticket settings. Thus, it includes first setting 516 and second 518 as well as the other settings in subset 514 including Nth setting 520. Set 512 also includes settings not in subset 514. For example, set 512 includes third setting 602, fourth setting 604 up to Zth setting 606. All the settings are not shown for brevity.

Setting usage 608 may show that third setting 602 is used over a specified amount, such as 50%, for print tickets when simplified user interface 502 is expanded to controller user interface 522. Alternatively, as second setting 518 is being removed, the disclosed embodiments may select the highest used setting not in subset 514, regardless of the specified amount. Third setting 602 may be recommended to the operator to replace second setting 518. Thus, the disclosed embodiments may dynamically generate simplified user interface 502 based on print ticket setting usage.

Setting usage 608 may use tracking on a printing device or system-wide level. It also may be generated per operator, per queue, per PDL type, or on a job action basis. In other words, simplified user interface 502 and subset 514 are dynamically adjustable based on different criteria to provide a more personalized group of print ticket settings based on the criteria. For example, a first operator may use second setting 518 more than 20% so that it is not recommended to be removed from subset 514. A second operation may not use second setting 518 more than 20% so that the disclosed embodiments may recommend that second setting 518 be replaced with third setting 602.

With regards to the type of job action, the disclosed embodiments may display different settings in simplified user interface 502 for a print job as compared to the print ticket settings for an estimate job. Print ticket 530 may differ for each type of job. Setting usage 608 may be tailored to the different job actions during tracking to configure subset 514 for each type of job action accordingly.

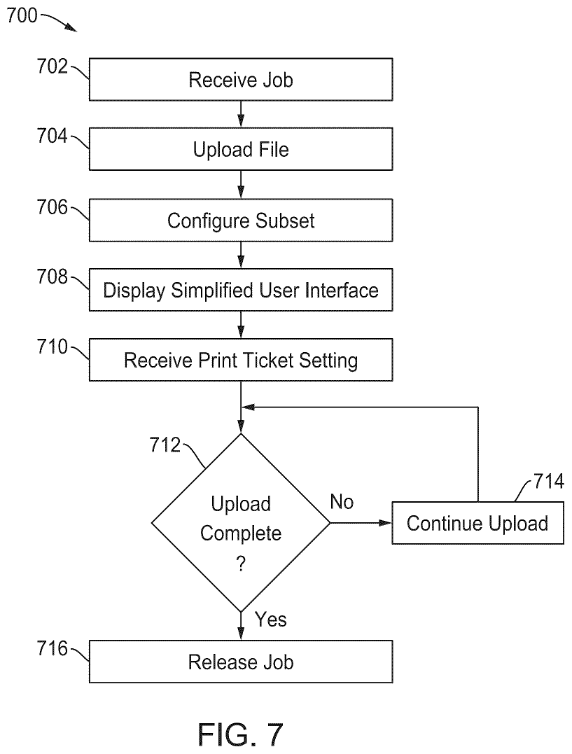

FIG. 7 depicts a flowchart 700 for submitting a job using simplified user interface 502 according to the disclosed embodiments. Flowchart 700 may refer to FIGS. 1-6 for illustrative purposes. Flowchart 700, however, is not limited by the embodiments disclosed by FIGS. 1-6.

Step 702 executes by receiving job 103 within controller user interface 522. In some embodiments, an icon of job 103 is dragged and dropped within controller user interface 522. Step 704 executes by uploading file 510 of job 103 to memory 508 of controller 106. The act of uploading may occur in the background as the other steps of flowchart 700 are executed.

Step 706 executes by configuring subset 514 of the print tickets settings with a reduced number of settings from set 512 of print ticket settings. For example, subset 514 may include 6-7 print ticket settings from an overall number of 80 settings in set 512. Controller 106 may configure subset 514 with the small group of print ticket settings based on controller settings or by operator selection. Further, subset 514 may be configured according to different criteria, such as job action, job type, operator, and the like.

Step 708 executes by displaying simplified user interface 502 with subset 514 of the print ticket settings. Step 708 may be executed while step 704 is executing. In other words, simplified user interface 502 may be configured and displayed while file 510 is uploading. Simplified user interface 502 includes the defined subset of print ticket settings.

Step 710 executes by receiving one or more print ticket settings of subset 512 using simplified user interface 502. The print ticket settings may be selected within simplified user interface 502. The selected print ticket settings then may be used to generate print ticket 530 that is associated with file 510.

Step 712 executes by determining whether uploading is complete for file 510. If no, then step 714 executes by continuing to upload file 510. Flowchart 700 returns to step 712. Alternatively, flowchart 700 may return to step 710. If step 712 is yes, then step 716 executes by releasing job 103 along with file 510 to continue printing operations. In some embodiments, the operator may select another printing device to print or process the job. If so, then controller 106 may forward file 510 along with print ticket 530 to the target printing device.

In some embodiments, step 712 may be replaced with determining whether print ticket 530 is complete before releasing file 510 for further processing. In other words, file 510 may complete uploading but the operator has not selected any print ticket settings from simplified use interface 502. In this situation, release of file 510 may not be done until print ticket 530 is generated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for submitting a print job for printing within a printing system, the method comprising:
receiving a file for a print job through a user interface for a digital front end (DFE) of a first printing device;
uploading the file for the print job within the printing system;
displaying a simplified user interface corresponding to the DFE during the uploading of the file for the print job to the DFE, wherein the simplified user interface includes a defined subset of print ticket settings for the print job;
receiving at least one print ticket setting of the defined subset of print ticket settings within the simplified user interface to apply to the print job; and
releasing the print job for printing operations by the DFE upon receipt of the at least one print ticket setting and upload of the file for the print job.

2. The method of claim 1, wherein the defined subset of print ticket settings includes at least one of a DFE queue, a job name, a project name, a number of copies, a paper catalog selection, and a job action.

3. The method of claim 1, wherein the defined subset of print ticket settings is configurable via at least one DFE setting.

4. The method of claim 1, wherein releasing the print job includes providing the print job to a print engine of the first printing device.

5. The method of claim 1, wherein uploading the file includes uploading the file to the DFE of the first printing device.

6. The method of claim 1, further comprising selecting a second printing device to receive the file for the print job and the at least one print ticket setting.

7. The method of claim 6, wherein uploading the file for the print job includes uploading the file to the second printing device.

8. The method of claim 6, further comprising deleting the file from the DFE of the first printing device.

9. The method of claim 1, further comprising expanding the defined subset of print ticket settings to include at least one additional print ticket setting.

10. The method of claim 1, further comprising holding the print job until the at least one print ticket setting is received.

11. The method of claim 1, further comprising
receiving an instruction to cancel the print job; and
performing one of cancelling upload of the file for the print job or deleting the file from the printing system if it is uploaded.

12. The method of claim 1, wherein the defined subset of print ticket settings is defined by tracking print ticket settings used at the first printing device or within the printing system.

13. The method of claim 12, further comprising removing a print ticket setting from the defined subset of print ticket settings based on the tracking.

14. The method of claim 12, further comprising adding a print ticket setting to the defined subset of print ticket settings based on the tracking.

15. A method for submitting a print job within a printing system, the method comprising:
receiving a file for a print job through a user interface for a digital front end (DFE) of a first printing device;
uploading the file for the print job within the printing system;
defining a subset of print ticket settings of a plurality of print ticket settings based on tracked usage of the plurality of print ticket settings;
generating a simplified user interface corresponding to the DFE during the uploading of the file for the print job to the DFE, wherein the simplified user interface includes the defined subset of print ticket settings for the print job;
receiving at least one print ticket setting of the defined subset of print ticket settings within the simplified user interface to apply to the print job; and
releasing the print job for printing operations by the DFE upon receipt of the at least one print ticket setting and upload of the file for the print job.

16. The method of claim 15, wherein the defined subset of print ticket settings includes at least one of a DFE queue, a job name, a project name, a number of copies, a paper catalog selection, and a job action.

17. The method of claim 15, further comprising selecting a second printing device to receive the file for the print job and the at least one print ticket setting.

18. The method of claim 15, further comprising expanding the defined subset of print ticket settings to include at least one additional print ticket setting from the plurality of print ticket settings.

19. A printing system comprising:
a first printing device having a digital front end (DFE); and
a user interface connected to the DFE,
wherein the DFE includes a processor and a memory, the memory storing instructions that, when executed on the processor, configures the DFE to
receive a file for a print job through the user interface;
upload the file for the print job;
display a simplified user interface corresponding to the DFE during the uploading of the file for the print job to the DFE, wherein the simplified user interface includes a defined subset of print ticket settings for the print job;
receive at least one print ticket setting of the defined subset of print ticket settings within the simplified user interface to apply to the print job; and
release the print job for printing operations by the DFE upon receipt of the at least one print ticket setting and upload of the file for the print job.

20. The printing system of claim 19, further comprising a second printing device, wherein the print job is released to the second printing device after the file is uploaded and the at least one print ticket setting is received.
